(19) United States
(12) Patent Application Publication
(10) Pub. No.: US 2013/0048397 A1
(43) Pub. Date: Feb. 28, 2013

(54) Individual Carrier/Transporter

(71) Applicant: Mark Stephen Averbeck, Redlands, CA (US)

(72) Inventor: Mark Stephen Averbeck, Redlands, CA (US)

(21) Appl. No.: 13/199,405

(22) Filed: Aug. 30, 2011

(51) Int. Cl. B62D 51/04; B62D 33/00

(52) U.S. Cl. 180/89.1

(57) ABSTRACT

My invention the Individual Carrier/Transporter is a new device that will allow an individual person to carry heavy bulky items from their vehicle to a gathering site in one trip. This unique invention will benefit millions of people by allowing them to quickly carry their goods to and from an event in a relatively easy manner. Prior to my invention, people had to carry bulky/heavy objects at great distances thus straining muscles. This device will simplify our lives and provide us more time to enjoy our activities.

### CROSS REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

My invention “Individual Carrier/Transporter” is a device I began thinking about eight years ago when I took my family to the beach. As the father, I had the responsibility of carrying the ice cooler, lawn chairs, blankets, food, beach umbrella, etc. I use to place as much of our belongings on a foam boogie board and drag the heavy goods across the beach.

As I slept that particular evening, I thought of the idea to develop a folding transportable device that could be driven by one person allowing them to carry all of their belongings to their beach gathering, camp site, or family event in one trip.

I took some notes the next day on my computer and actually called the patent office to investigate obtaining a patent. I believe I ordered some materials however I never filed for a patent until now.

My claim for this utility patent is there is a definite need for all persons in our society to manually carry goods to one particular place from another. If a beach goer has to park a mile away, then they will be forced to either make multiple trips or perhaps drop the family off with their items and then locate a parking spot. This individual carrier/transporter will empower an individual to safely carry all of their belongings and still allow the family to keep from being separated.

Since this device will be able to travel over sand, pavement, and dirt it may also help prevent unnecessary strains on their muscles or injury due the device carrying all of the weight.

In the steam of commerce there is no device available such as mine. Our society needs an electrically powered carrier designed in a compact fashion for domestic purposes.

### BRIEF SUMMARY OF THE INVENTION

A summary of my invention is the “Individual Carrier/Transporter” allows one person to actually transport all of their family's goods for an outing to their destination in one trip. This invention is an electrically powered compactable carrier that will simplify millions of people's lives. It will be able to be driven over multiple surfaces of sand, pavement, and dirt. It may even prevent strained muscles or injury to those owners who would have otherwise had to manually carry their goods to their destination.

This invention solves a preexisting problem of how hard it is to manage carrying their goods from one particular location to another. Carrying bulky lawn chairs, ice coolers, beach umbrellas is always a cumbersome and muscle aching chore. My invention will allow one person to carry the goods thus relieving stress from everyone involved.

The object of this invention is to simplify the lives of people who enjoy spending a quality day with their family on outings. This invention will allow one adult to transport their belongings while the other adults can monitor their children's safety.

### BRIEF DESCRIPTION OF THE SEVERAL VIEWS OF THE DRAWING

FIG. 1 is a drawing of a partially folded carrier/transporter.

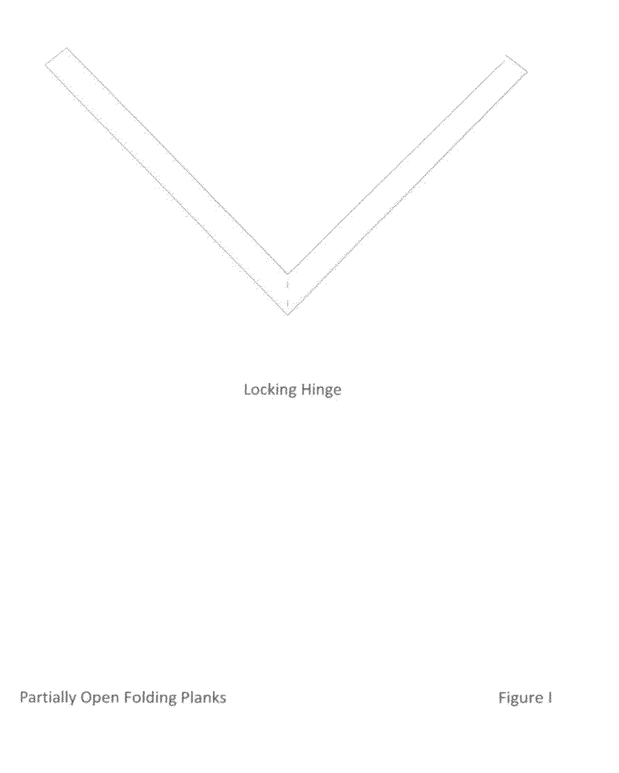

FIG. 2 is a drawing of a closed side view of the carrier/transporter.

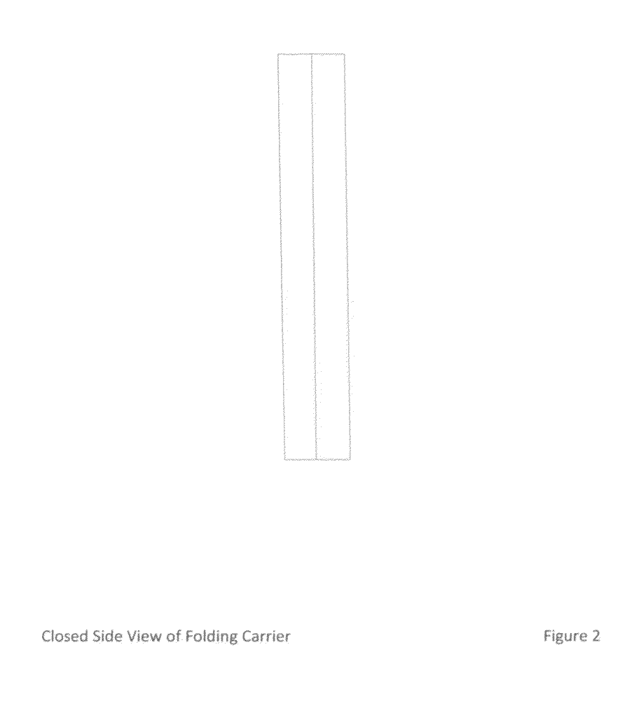

FIG. 3 is a drawing side view of the carrier/transporter open with locking poles extended.

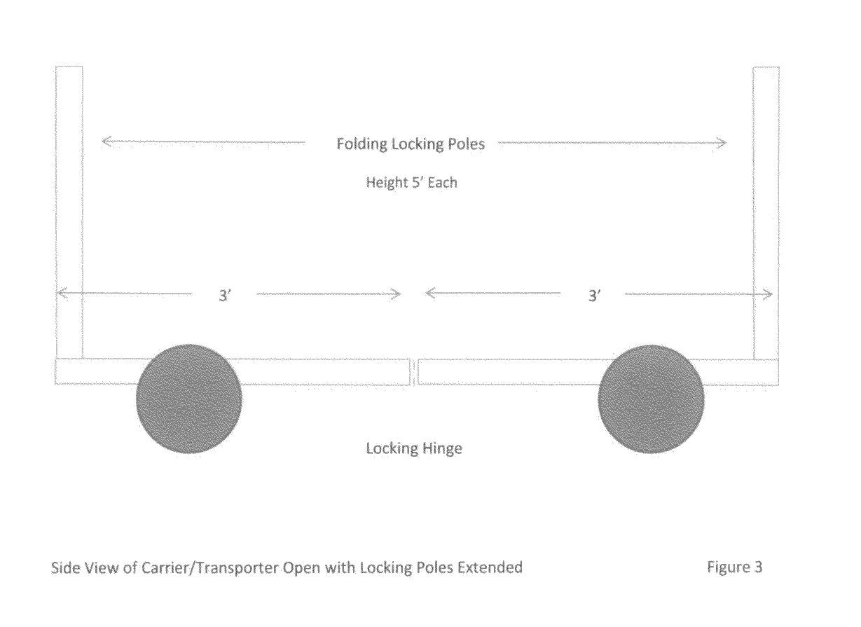

FIG. 4 is a drawing of an aerial view of the carrier/transporter.

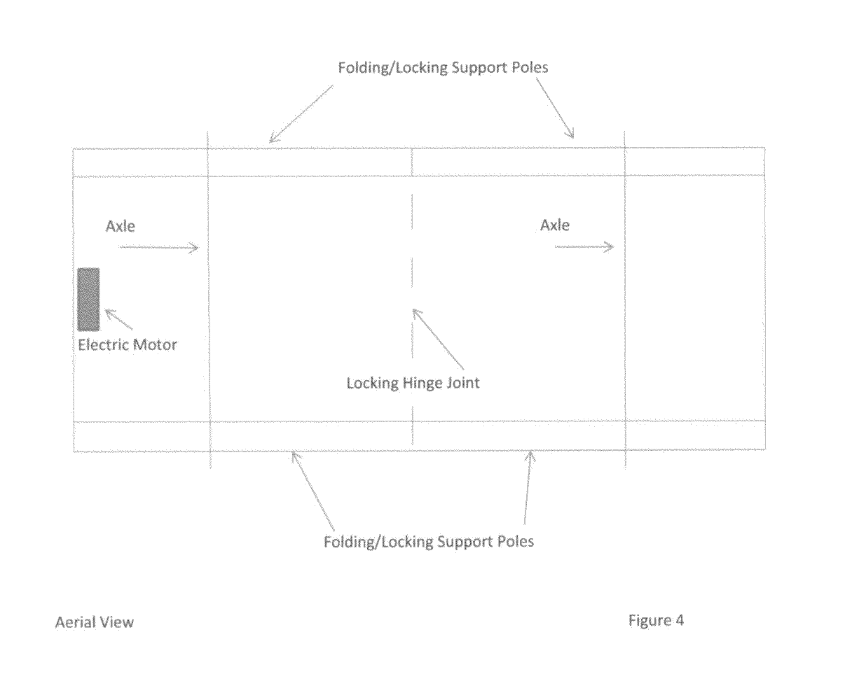

FIG. 5 is a drawing of the carrier/transporter in the locked open position, the poles extended, with the nylon net wrapped around the poles to secure the owners belongings.

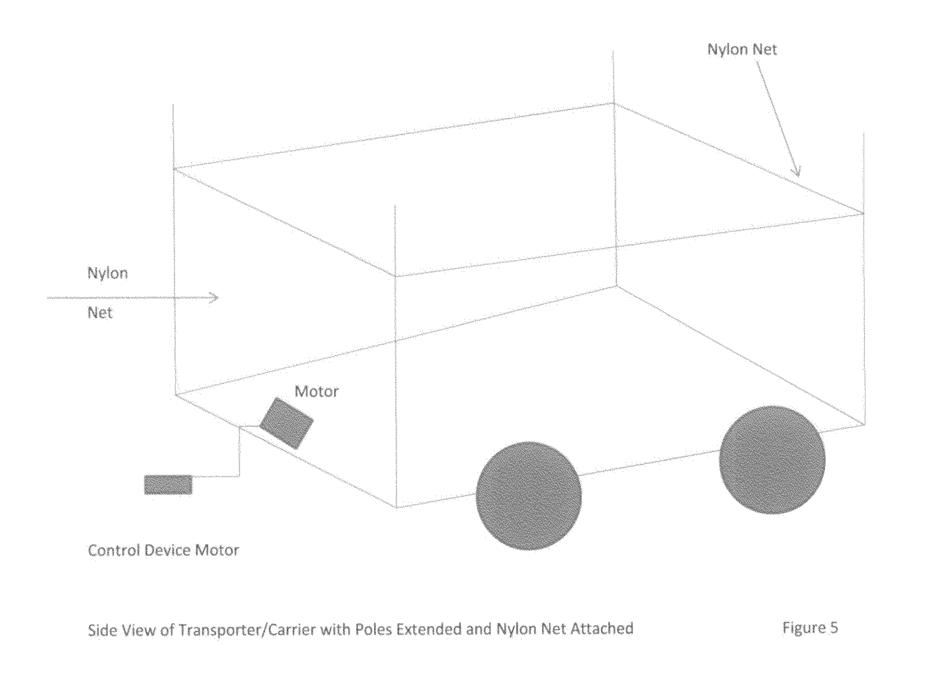

### DETAILED DESCRIPTION OF THE INVENTION

The individual carrier/transporter I would like to market to the stream of commerce will initially be available as:

Total length of 6′

Two separate planks 3′ length attached to each other with a folding/locking hinge

The planks will be constructed out of a durable light material (plastic/fiberglass).

There will be a five foot folding/locking pole attached at the corner of each plank allowing the owner to extend the poles creating a rectangular frame for the net that will hold their belongings in place.

There will be a nylon net wrapped around the four poles that will secure the belongings once it has been tightly fastened in place.

There will be a rechargeable electric motor attached to the front of the carrier thus providing power to the front two wheels of the device.

The rear two wheels will roll freely when the motor drives the front two sets of wheels.

The tires will be made holding sufficient air pressure allowing the carrier to travel across the sand, pavement, and dirt.

The front axle will be able to maneuver to the right or left and the direction will be controlled by the electric motor as directed by the operator.

Larger or smaller versions of the carrier/transporter may be manufactured to accommodate the market place.

### Specification

My invention is a device I began thinking about eight years ago. It will enable one person to transport an entire family's belongings for an outing in one single trip. It will be able to fold up making it easily stored in the family vehicle until the owner is ready to transport their belongings.

The individual carrier/transporter I would like to market to the stream of commerce will initially be available as:

Total length of 6′

Two separate planks 3′ length attached to each other with a folding/locking hinge

The planks will be constructed out of a durable light material (plastic/fiberglass).

There will be a five foot folding/locking pole attached at the corner of each plank allowing the owner to extend the poles creating a rectangular frame for the net that will hold their belongings in place.

There will be a nylon net wrapped around the four poles that will secure the belongings once it has been tightly fastened in place.

There will be a rechargeable electric motor attached to the front of the carrier thus providing power to the front two wheels of the device.

The rear two wheels will roll freely when the motor drives the front two sets of wheels.

The tires will be made holding sufficient air pressure allowing the carrier to travel across the sand, pavement, and dirt.

The front axle will be able to maneuver to the right or left and the direction will be controlled by the electric motor as directed by the operator.

1. There is definite need for this device since millions of people gather with their families/friends every week transporting food, drinks, etc. from their vehicle to their destination.
The components that make my invention new and useful are:
The fact that this is a first of it's kind device that enables a person to deploy two planks attached with a locking hinge, has wheels, a rechargeable electric motor, coupled with four locking support poles, and a nylon net makes this an innovative method to move personal belongings from one place to another.
The fact that this invention folds up and uses minimum storage space makes it a valuable tool for the consumer. It can easily be stowed in a small car until the owner is ready to deploy the device.
This device is unique because it has two folding planks used to support goods, four locking/folding poles used to support the nylon wrap, it is powered by a rechargeable electric motor, has wheels that will permit the device to travel on sand, pavement, and dirt.
One individual will be able to transport the goods for several people in one trip with the eclectically powered “Individual Carrier/Transporter.”
